(19) United States
(12) Patent Application Publication
(10) Pub. No.: US 2017/0311068 A1
(43) Pub. Date: Oct. 26, 2017

(54) EARSET AND METHOD OF CONTROLLING THE SAME

(71) Applicant: Haebora Co., Ltd., Seoul (KR)

(72) Inventor: Doo Sik SHIN, Seoul (KR)

(21) Appl. No.: 15/342,130

(22) Filed: Nov. 3, 2016

(30) Foreign Application Priority Data
Apr. 25, 2016 (KR) 10-2016-0050134

(51) Int. Cl. H04R 1/10; G10L 21/003; G10L 25/78

(52) U.S. Cl. CPC H04R 1/1016; G10L 25/78; G10L 21/003; H04R 2201/107

(57) ABSTRACT

Disclosed herein are an earset capable of correcting voice coming out at a user's ear using voice coming out of the user's mouth and a method of controlling the same.

An earset system according to an embodiment includes an earset having a first microphone and a first earphone inserted into the user's ear; and a controller configured to correct, based on a correction value, a first voice signal acquired through the first microphone using a reference voice signal coming out of the user's mouth when voice coming out at the user's ear is input into the first microphone.

### RELATED APPLICATION

This application claims the benefit of priority of Korean Patent Application No. 10-2016-0050134 filed Apr. 25, 2016, the contents of which are incorporated herein by reference in their entirety.

### FIELD AND BACKGROUND OF THE INVENTION

Disclosed herein are an earset and a method of controlling the same. More particularly, disclosed herein are an earset that corrects a voice signal coming out at an ear using a voice signal coming out of a mouth and outputs the voice signal coming out at the ear and a method of controlling the same.

The use of an earset is increasing with increasing use of mobile phones. An earset refers to a device having a microphone and a speaker installed therein. Because hands are free when an earset is used, a user may multitask while on the phone.

However, a conventional earset has a structure in which only a speaker is disposed inside a user's ear and a microphone is disposed outside the user's ear. Consequently, a howling phenomenon occurs while using the phone, in which ambient noise is input into the microphone and output again to the speaker. The howling phenomenon becomes a cause of degrading call quality.

To overcome the problem, an earset including an ear insertion type microphone has been developed, in which both a speaker and a microphone are disposed inside an ear so that a call is performed only using sound coming out at a user's ear and sound outside the user' ear is blocked.

However, when the earset including an ear insertion type microphone is used, a reverberation phenomenon may occur during the use because voice comes out of an auditory tube, and it may be difficult to communicate clearly.

### RELATED ART DOCUMENT

### Patent Document

(Patent Document 0001) Korean Patent Registration No. 10-1504661 (Title of Invention: Earset, Registration date: Mar. 16, 2015)

### SUMMARY OF THE INVENTION

Disclosed herein are an earset capable of correcting voice coming out at a user's ear using voice coming out of the user's mouth or correcting voice coming out of a user's mouth using voice coming out at the user's ear, and a method of controlling the same.

To achieve the above aspect, an earset system according to an embodiment includes an earset having a first earphone inserted into a user's ear and having a first microphone configured to receive voice coming out at the user's ear; and a controller configured to correct, based on a correction value, a first voice signal acquired through the first microphone or a voice signal coming out of the user's mouth using a reference voice signal.

The controller may include a corrector configured to correct, based on the correction value, the first voice signal using a voice signal coming out of the user's mouth which is a reference voice signal or correct a voice signal coming out of the user's mouth using the first voice signal which is the reference voice signal.

The correction value may be acquired by analyzing the reference voice signal in advance.

The correction value may be stored in at least one of the earset and an external device of the user linked to the earset.

The correction value stored in the earset may be transmitted to the external device according to wired and wireless communication means. Alternatively, the correction value stored in the external device may be transmitted to the earset according to wired and wireless communication means.

The correction value may be acquired or estimated in real time from the first voice signal.

The correction value may be acquired or estimated in real time from an external voice signal acquired through one or more external microphones.

The one or more external microphones may be disposed in at least one of a main body connected to the first earphone and an external device linked to the earset.

The one or more external microphones may be automatically activated when voice coming out of the user's mouth is sensed

The one or more external microphones may be automatically deactivated after voice coming out of the user's mouth is input.

The one or more external microphones may be automatically deactivated when voice coming out of the user's mouth is not sensed.

The corrector may distinguish the type of the reference voice signal based on information detected from the reference voice signal, may correct a frequency band of the first voice signal using a first reference frequency band acquired by analyzing a female voice when the type of the reference voice signal corresponds to a female voice signal, and may correct the frequency band of the first voice signal using a second reference frequency band acquired by analyzing a male voice when the type of the reference voice signal corresponds to a male voice signal.

The controller may include a detector configured to detect information from the reference voice signal.

At least one of the detector and the corrector is installed as a circuit or stored in a software form in at least one of the earset and an external device of the user linked to the earset.

The controller may perform voice signal processing of at least one of the first voice signal and the voice signal coming out of the user's mouth.

The voice signal processing may include transforming a frequency of a voice signal, extending the frequency of the voice signal, controlling gain of the voice signal, adjusting a frequency characteristic of the voice signal, removing an acoustic echo from the voice signal, removing noise from the voice signal, suppressing noise from the voice signal, cancelling noise from the voice signal, Z-transformation, S-transformation, Fast Fourier Transform (FFT), or a combination thereof.

The first earphone may include a first speaker configured to output an acoustic signal or a voice signal received from an external device.

The earset may further include a second earphone inserted into the user's ear. The second earphone may include at least one of a second microphone and a second speaker.

The earset may further include a communicator configured to communicate with an external device of the user. The communicator may support a wired communication means or a wireless communication means.

The communicator may transmit the correction value stored in the earset to the external device or receive the correction value stored in the external device from the external device.

### BRIEF DESCRIPTION OF THE SEVERAL VIEWS OF THE DRAWINGS

The above and other objects, features and advantages of the present invention will become more apparent to those of ordinary skill in the art by describing in detail exemplary embodiments thereof with reference to the accompanying drawings, in which:

FIG. 1 is a view illustrating a configuration of an earset system according to an embodiment;

FIG. 2 is a view illustrating a configuration of an earset according to an embodiment;

FIG. 3 is a view illustrating a configuration of an earset according to another embodiment;

FIG. 4 is a view illustrating a configuration of an earset according to yet another embodiment;

FIG. 5 is a view illustrating a configuration of an earset according to still another embodiment;

FIG. 6 is a view illustrating a configuration of an earset according to still another embodiment;

FIG. 7 is a view illustrating a configuration of a controller illustrated in FIGS. 2 to 6 according to an embodiment;

FIG. 8 is a view illustrating a configuration of the controller illustrated in FIGS. 2 to 6 according to another embodiment;

FIG. 9 is a view illustrating a configuration of an earset and a configuration of an external device according to still another embodiment;

FIG. 10 is a view illustrating a configuration of a controller of the external device illustrated in FIG. 9 according to an embodiment;

FIG. 11 is a view illustrating a configuration of a controller of the external device illustrated in FIG. 9 according to another embodiment;

FIG. 12 is a flowchart of a method of controlling an earset illustrated in FIGS. 2 to 11 according to an embodiment;

FIG. 13 is a flowchart of a method of controlling the earset illustrated in FIGS. 2 to 11 according to another embodiment;

FIG. 14 is a view illustrating a configuration of an earset according to still another embodiment;

FIG. 15 is a view illustrating a configuration of a controller illustrated in FIG. 14;

FIG. 16 is a flowchart of a method of controlling an earset illustrated in FIGS. 14 and 15 according to an embodiment; and

FIG. 17 is a flowchart of a method of controlling the earset illustrated in FIGS. 14 and 15 according to another embodiment.

### DESCRIPTION OF SPECIFIC EMBODIMENTS OF THE INVENTION

Advantages and features of the present disclosure and methods of achieving the same will become apparent by referring to embodiments that will be described in detail below with reference to the accompanying drawings. However, the present disclosure is not limited to the embodiments that will be described below and may be realized in other various forms. The embodiments are merely provided to make the present disclosure complete and to thoroughly inform one of ordinary skill in the art to which the present disclosure pertains of the scope of the present disclosure, and the present disclosure is defined only by the scope of the claims.

Unless otherwise defined, all terms used herein (including technical or scientific terms) have the same meaning as commonly understood by one of ordinary skill in the art to which the present disclosure pertains. Also, terms defined in commonly used dictionaries should not be construed in an idealized or overly formal sense unless expressly so defined herein.

Terms used herein are merely used to describe particular embodiments and are not intended to limit the present disclosure. A singular expression includes a plural expression unless the context clearly indicates otherwise. Terms such as “includes” and/or “including” do not preclude the existence of or the possibility of adding one or more other elements besides those that are mentioned.

Hereinafter, embodiments of the present disclosure will be described with reference to the accompanying drawings. Like reference numerals represent like elements throughout the drawings.

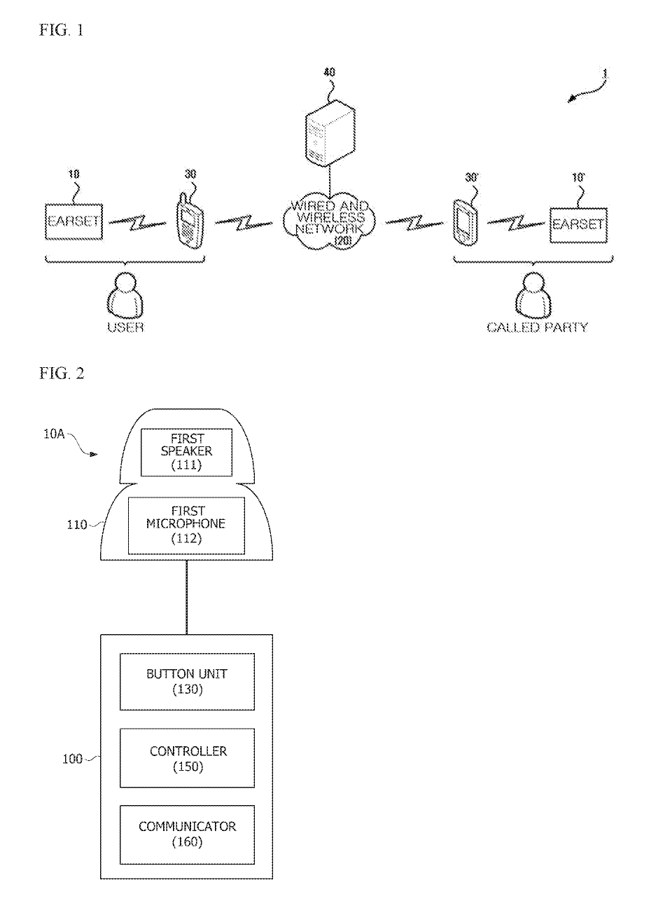

FIG. 1 is a view illustrating a configuration of an earset system according to an embodiment.

Referring to FIG. 1, an earset system 1 may include an earset 10 of a user and an external device 30 of the user. The earset system 1 may further include at least one of an external device 30′ of a called party, an earset 10′ of the called party, and a server 40. The earset 10 of the user and the earset 10′ of the called party may be substantially the same type of device, and the external device 30 of the user and the external device 30′ of the called party may be substantially the same type of device. Hereinafter, the earset 10 of the user and the external device 30 of the user will be mainly described.

The earset 10 is a device inserted into the user's ear. The earset 10 may transform a voice signal coming out at the user's ear to a voice signal coming out of the user's mouth or transform a voice signal coming out of the user's mouth to a voice signal coming out at the user's ear and transmit the transformed signal to the external device 30 through a wired and wireless network 20. Also, the earset 10 may receive an acoustic signal or a voice signal from the external device 30 through the wired and wireless network 20. The configuration of the earset 10 will be described in more detail below with reference to FIGS. 2 to 6.

The external device 30 transmits an acoustic signal or a called party's voice signal to the earset 10 through the wired and wireless network 20 and receives the user's voice signal from the earset 10. According to an embodiment, the external device 30 may receive a corrected voice signal from the earset 10. According to another embodiment, the external device 30 receives a first microphone 112 (see FIG. 4) voice signal (hereinafter, referred to as a first voice signal) and/or a second microphone 122 (see FIG. 4) voice signal (hereinafter, referred to as a second voice signal) from the earset 10 and then corrects the first voice signal and/or the second voice signal based on an external voice signal. Here, an external voice signal refers to a voice signal corresponding to voice coming out of the user's mouth.

An external voice signal may be acquired through an external microphone. For example, an external microphone may refer to a microphone 140 (see FIG. 14) disposed in a main body of the earset 10. In another example, an external microphone may refer to a microphone (not illustrated) disposed in the external device 30. An external voice signal may be acquired in advance through an external microphone or may be acquired in real time through the external microphone.

Meanwhile, according to an embodiment other than that in which the first voice signal and/or the second voice signal are corrected based on an external voice signal, an external voice signal may be corrected based on the first voice signal and/or the second voice signal. A voice signal that will be corrected may be set by a user through the external device 30 or the earset 10. Hereinafter, a voice signal that becomes a reference for correcting a voice signal will be referred to as a reference voice signal for convenience of description. In the example described above, the external voice signal may correspond to a reference voice signal when attempting to correct the first voice signal and/or the second voice signal based on the external voice signal. When attempting to correct an external voice signal based on the first voice signal or the second voice signal, the first voice signal or the second voice signal may correspond to a reference voice signal.

When the external device 30 transmits and receives a signal through a wireless network, a wireless communication means among ultra-wide band, ZigBee, wireless fidelity (Wi-Fi), and Bluetooth may be used. However, the wireless communication means is not necessarily limited to those mentioned above.

When the external device 30 communicates with the earset 10 according to a wireless communication means, a pairing process may be performed between the external device 30 and the earset 10 in advance. The pairing process refers to a process of registering device information of the earset 10 in the external device 30 and registering device information of the external device 30 in the earset 10. When a signal is transmitted or received with the pairing process completed, security of the transmitted or received signal may be maintained.

The external device 30 may include wired and wireless communication devices. Examples of wired and wireless communication devices may include a palm personal computer (PC), a personal digital assistant (PDA), a wireless application protocol (WAP) phone, a smartphone, a smart pad, and a mobile playstation. The external device 30 whose examples have been given above may be a wearable device that may be worn on a part of a user's body, e.g., head, wrist, finger, arm, or waist. Although not illustrated in the drawings, the external device 30 whose examples have been given above may include a microphone and a speaker. Here, the microphone may receive voice coming out of a user's mouth and output an external voice signal.

FIGS. 2 to 6 are views illustrating various embodiments of a configuration of the earset 10.

First, referring to FIG. 2, an earset 10A according to an embodiment includes a first earphone 110 and a main body 100.

The first earphone 110 includes a first speaker 111 and a first microphone 112 and is inserted into a first external auditory meatus (e.g., an external auditory meatus of the left ear) of a user. The shape of the first earphone 110 may correspond to a shape of the first external auditory meatus. Alternatively, the first earphone 110 may have any shape capable of being inserted into an ear regardless of the shape of the first external auditory meatus.

The first speaker 111 outputs an acoustic signal or a voice signal received from the external device 30. The output signal is transmitted to an eardrum along the first external auditory meatus. The first microphone 112 receives voice coming out at a user's ear. When both of the first speaker 111 and the first microphone 112 are disposed in the first microphone 110 as described above, clear call quality may be maintained even in a noisy environment because external noise may be prevented from being input into the first microphone 112.

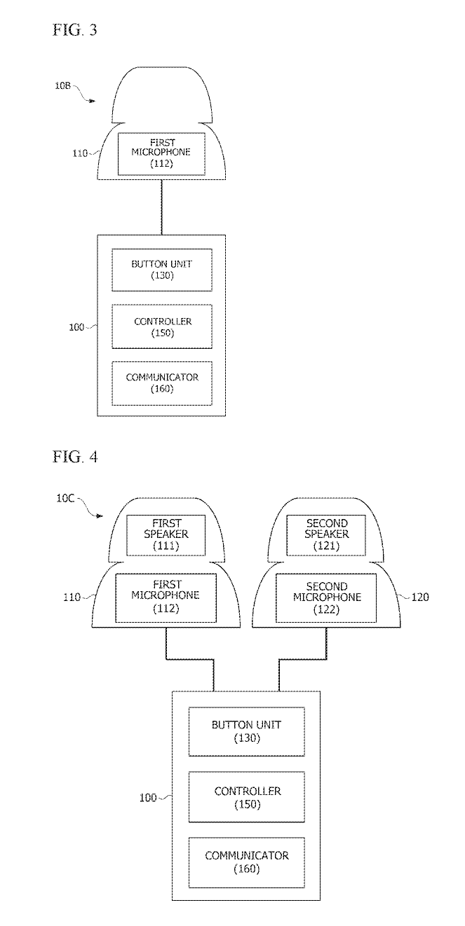

Meanwhile, referring to FIG. 3, an earset 10B according to another embodiment may include the first earphone 110, but the first earphone 110 may only include the first microphone 112.

Referring to FIG. 4, an earset 10C according to yet another embodiment may include the first earphone 110 and a second earphone 120. The first earphone 110 may include the first speaker 111 and the first microphone 112, and the second earphone 120 may include a second speaker 121 and a second microphone 122. The second earphone 120 is inserted into a second external auditory meatus.

Referring to FIG. 5, an earset 10D according to still another embodiment may include the first earphone 110 and the second earphone 120. The first earphone 110 may include the first speaker 111 and the first microphone 112, and the second earphone 120 may only include the second speaker 121.

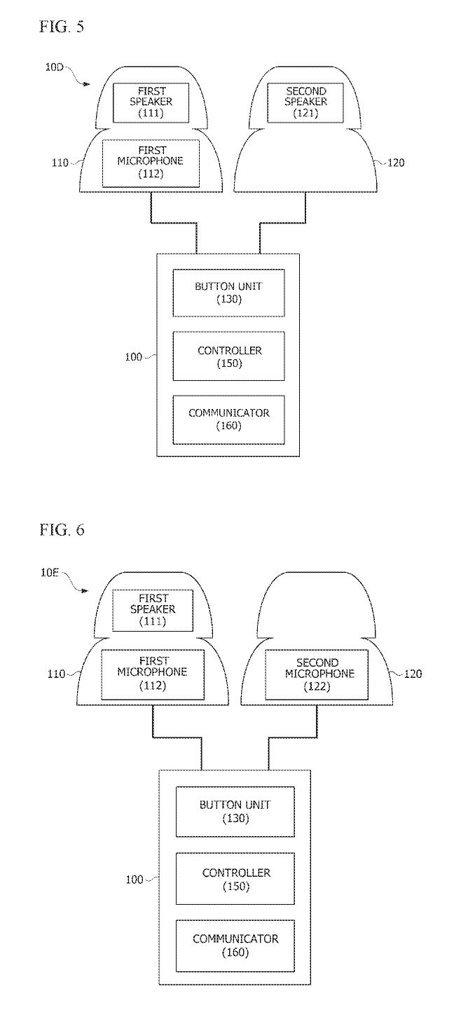

Referring to FIG. 6, an earset 10E according to still another embodiment may include the first earphone 110 and the second earphone 120. The first earphone 110 may include the first speaker 111 and the first microphone 112, and the second earphone 120 may only include the second microphone 122.

Referring to FIGS. 2 to 6, the main body 100 is electrically connected to the first earphone 110. The main body 100 may be exposed outside a user's ear. The main body 100 corrects voice coming out at the user's ear using voice coming out of a user's mouth and transmits the corrected voice signal to the external device 30. For this, the main body 100 may include a button unit 130, a controller 150, and a communicator 160.

The button unit 130 may include buttons capable of receiving commands required to operate the earset 10A. For example, the button unit 130 may include a power button configured to supply power to the earset 10A, a pairing execution button configured to execute a pairing operation with the external device 30, a reference voice signal setting button, a voice correction mode setting button, and a voice correction execution button.

The reference voice signal setting button is a button for setting one of the first voice signal, the second voice signal, and the external voice signal as a reference voice signal. That is, a user may use the reference voice signal setting button to set whether the first voice signal and/or the second voice signal will be corrected based on the external voice signal or the external voice signal will be corrected based on the first voice signal and/or the second voice signal.

The voice correction mode setting button is a button for setting a mode related to voice signal correction. Examples of a voice signal correction mode may include a normal correction mode and a real-time correction mode. The normal correction mode refers to correcting a voice signal based on a pre-stored reference voice signal. The real-time correction mode refers to correcting a voice signal based on a reference voice signal acquired in real time.

The voice correction execution button may activate or deactivate a voice correction function. For example, the voice correction execution button may be realized using an on/off button. The voice correction function may be activated when the voice correction execution button is turned on, and the voice correction function may be deactivated when the voice correction execution button is turned off.

The buttons listed above as examples may be realized using separate buttons in a hardware form or a single button in a hardware form. When the buttons listed above as examples are realized using a single button in the hardware form, different commands may be input according to a button manipulation pattern. For example, different commands may be input according to manipulation patterns such as the number of times a button is operated within a predetermined amount of time and the amount of time a button is operated.

Although buttons disposed in the button unit 130 have been described above, the buttons listed above as examples are not necessarily disposed in the button unit 130, and the number or types of buttons may differ according to circumstances. For example, the voice correction execution button may be omitted. In this case, voice correction may automatically be executed when a user performing a call using the earset 10A is detected. Alternatively, a correction signal acquired in advance may be output.

According to another embodiment, the button unit 130 may be omitted. In this case, a command for controlling an operation of the earset 10A may be received from the external device 30. Specifically, the user may input a command related to the type of a reference voice signal, the type of a voice correction mode, whether to execute voice correction, etc. through a voice correction application installed in the external device 30. Hereinafter, a case in which the voice correction execution button is disposed will be described as an example for convenience of description.

The communicator 160 transmits and receives a signal through the external device 30 and the wired and wireless network 20. For example, the communicator 160 receives an acoustic signal or a voice signal from the external device 30. In another example, when a voice coming out at a user's ear is corrected using a voice coming out of the user's mouth, the communicator 160 transmits the corrected voice signal to the external device 30. Moreover, the communicator 160 may transmit and receive a control signal required for a pairing process between the earsets 10A, 10B, 10C, 10D, 10E and the external device 30. For this, the communicator 160 may support at least one wireless communication means among ultra-wide band, ZigBee, Wi-Fi, and Bluetooth or support a wired communication means.

The controller 150 may connect each of the elements of the earsets 10A, 10B, 10C, 10D, and 10E. Also, the controller 150 may determine whether the voice correction function is activated and control each of the elements of the earsets 10A, 10B, 10C, 10D, and 10E according to the determination result.

Specifically, when the voice correction function is activated, the controller 150 corrects voice input into the first microphone 112 and/or the second microphone 122 using voice that has come out of a user's mouth or corrects voice that has come out of a user's mouth using voice that has come out at the user's ear. When the voice correction function is deactivated, the controller 150 processes each voice input into the first microphone 112 and the second microphone 122 and transmits the processed voice signals to the external device 30.

When the voice correction execution button is omitted in the button unit 130 and activation or deactivation of the voice correction function cannot be selected, the controller 150 transmits a correction signal acquired in advance to the external device 30.

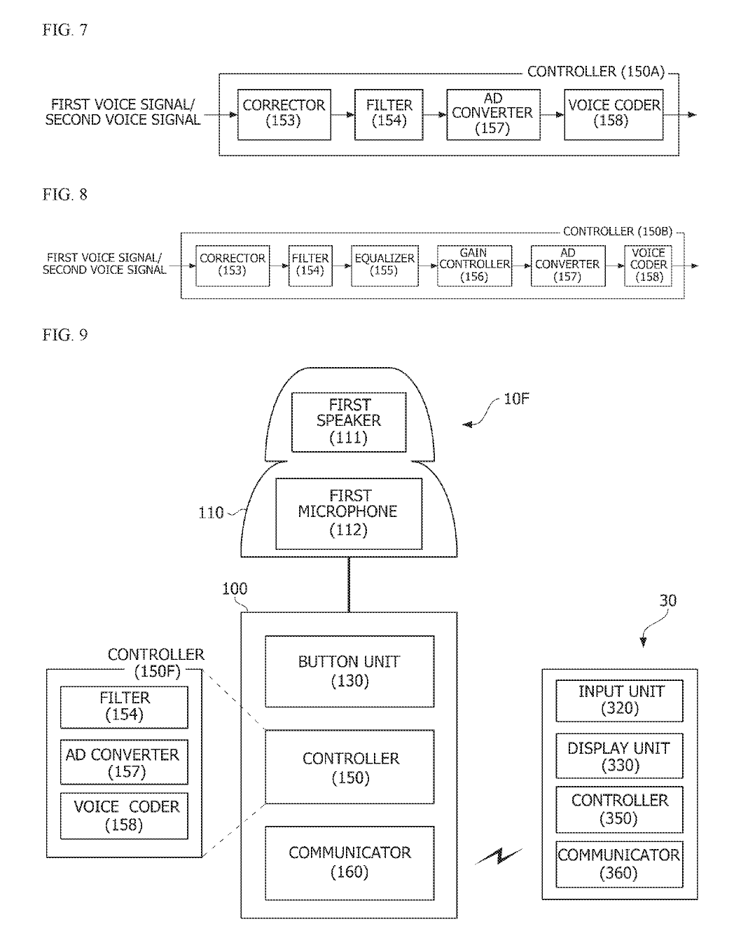

FIG. 7 is a view illustrating a configuration of the controller 150 of the earsets 10A, 10B, 10C, 10D, and 10E according to an embodiment. FIG. 8 is a view illustrating a configuration of the controller 150 of the earsets 10A, 10B, 10C, 10D, and 10E according to another embodiment.

First, referring to FIG. 7, a controller 150A according to an embodiment may include a corrector 153, a filter 154, an analog-digital (AD) converter 157, and a voice coder 158.

The corrector 153 corrects at least one of the first voice signal, the second voice signal, and the external voice signal using a reference voice signal. For example, when the external voice signal is a reference voice signal, the corrector 153 corrects a frequency band of the first voice signal and/or a frequency band of the second voice signal using a frequency band of the external voice signal which is the reference voice signal. Because the first voice signal and/or the second voice signal is a voice signal based on voice that has come out at a user's ear, and the external voice signal which is the reference voice signal is a voice signal based on voice that has come out of the user's mouth, it may be understood that the corrector 153 corrects voice coming out at the user's ear using voice coming out of the user's mouth.

In another example, when the first voice signal is a reference voice signal, the corrector 153 corrects a frequency band of the external voice signal using a frequency band of the first voice signal which is the reference voice signal. That is, it may be understood that the corrector 153 corrects voice coming out of the user's mouth using voice coming out at the user's ear. Hereinafter, a case in which the external voice signal is a reference voice signal will be described as an example for convenience of description.

The corrector 153 corrects the first voice signal and/or the second voice signal using the reference voice signal, with reference to a correction value. Here, the correction value may be experimentally acquired in advance. The correction value acquired in advance may be stored in the corrector 153 when the earsets 10A, 10B, 10C, 10D, and 10E are manufactured. In another example, the correction value may also be acquired through a voice correction application installed in the external device 30 and stored in the corrector 153 after being transmitted to the corrector 153 of the earsets 10A, 10B, 10C, 10D, and 10E according to wired and wireless communication means.

Although not illustrated in the drawings, the corrector 153 may further include a filter, an equalizer, a gain controller, or a combination thereof.

The filter 154 filters a corrected voice signal to remove an acoustic echo and noise therefrom. For this, the filter 154 may include one or more filters, e.g., an acoustic echo removing filter and a noise removing filter. A voice signal from which an acoustic echo and noise have been removed is provided to the AD converter 157.

The AD converter 157 converts the voice signal from which an acoustic echo and noise have been removed from an analog signal to a digital signal. The voice signal converted to a digital signal is provided to the voice coder 158.

The voice coder 158 codes the voice signal converted to a digital signal. The coded voice signal may be transmitted to the external device 30 through the communicator 160. The voice coder 158 may use one of a voice waveform coding means, a vocoding means, and a hybrid coding means when coding a voice signal.

The voice waveform coding means refers to a technology of transmitting information on a voice waveform itself. The vocoding means is a means for extracting a characteristic parameter from a voice signal based on a generation model of the voice signal and transmitting the extracted characteristic parameter to the external device 30. The hybrid coding means is a means in which advantages of the voice waveform coding means and the vocoding means are combined. The hybrid coding means analyzes a voice signal and removes a characteristic of a voice using the vocoding means and transmits an error signal from which the characteristic has been removed using the voice waveform coding means. A means for coding a voice signal may be preset, and a set value may be changed by a user.

When the vocoding means is used among the coding means listed above, the voice coder 158 may determine speed and amplitude of a voice signal converted into a digital signal and code the voice signal by changing coding rate.

A case in which the corrector 153 is disposed in front of the filter 154 has been described as an example with reference to FIG. 7. Although not illustrated in the drawings, the corrector 153 may also be disposed behind the filter 154.

Next, referring to FIG. 8, a controller 150B according to another embodiment may include the corrector 153, the filter 154, an equalizer 155, a gain controller 156, the AD converter 157, and the voice coder 158. Because elements illustrated in FIG. 8 are similar or almost identical to those illustrated in FIG. 7, overlapping descriptions will be omitted and differences from the elements in FIG. 7 will be mainly described.

The filter 154 filters a voice signal corrected by the corrector 153 to remove an acoustic echo and noise therefrom. A voice signal from which an acoustic echo and noise have been removed is provided to the equalizer 155.

The equalizer 155 adjusts overall frequency characteristic of a voice signal output from the filter 154. A voice signal whose frequency characteristic is adjusted is provided to the gain controller 156.

The gain controller 156 applies a gain to a voice signal output from the equalizer 155 to adjust size of the voice signal. That is, the size of the voice signal is amplified when the size of the voice signal output from the equalizer 155 is small, and the size of the voice signal is reduced when the size of the voice signal output from the equalizer 155 is large. In this way, a voice signal having a predetermined size may be transmitted to the external device 30 of the user. The gain controller 156 may include, for example, an automatic gain controller.

The AD converter 157 converts a voice signal output from the gain controller 156 from an analog signal to a digital signal.

The voice coder 158 codes the voice signal converted into a digital signal. The coded voice signal may be transmitted to the external device 30 through the communicator 160. The voice coder 158 may use one of the voice waveform coding means, the vocoding means, and the hybrid coding means when coding a voice signal.

A case in which the corrector 153 is disposed in front of the filter 154 has been described as an example with reference to FIG. 8. Although not illustrated in the drawings, the corrector 153 may also be disposed behind the filter 154.

The earsets 10A, 10B, 10C, 10D, and 10E according to various embodiments have been described above with reference to FIGS. 2 to 6, and the controller 150 of the earsets 10A, 10B, 10C, 10D, and 10E according to various embodiments has been described above with reference to FIGS. 7 and 8. A case has been described as an example with reference to FIGS. 2 to 6, in which an operation of correcting voice input into the first microphone 112 and/or voice input into the second microphone 122 is performed in the earsets 10A, 10B, 10C, 10D, and 10E according to whether the voice correction function is activated. However, the operation is not necessarily performed in the earsets 10A, 10B, 10C, 10D, and 10E.

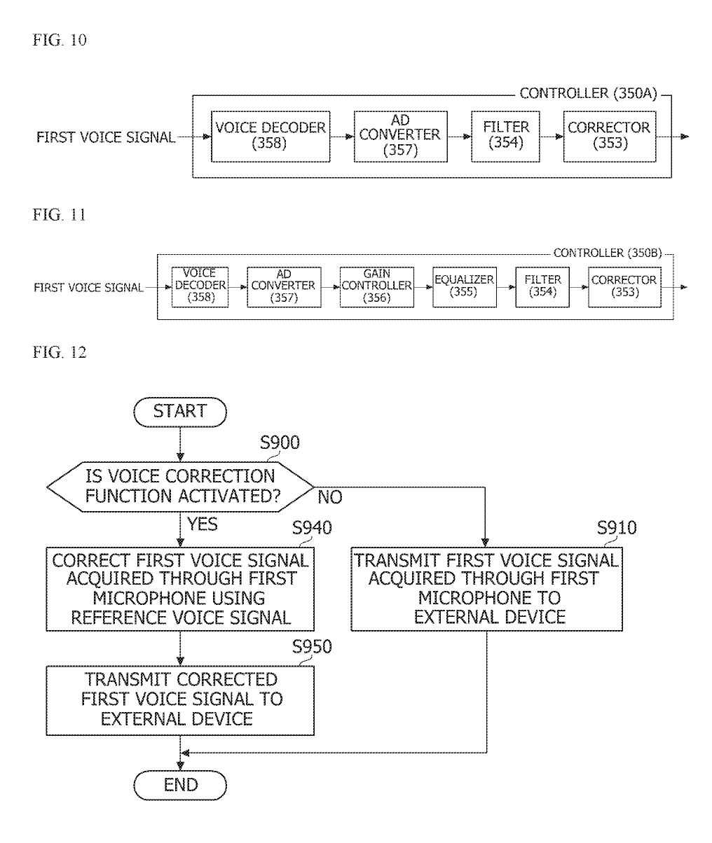

According to still another embodiment, an operation of correcting voice input into the first microphone 112 and/or voice input into the second microphone 122 may also be performed in the external device 30 according to whether the voice correction function is activated. Hereinafter, an earset 10F according to still another embodiment will be described with reference to FIGS. 9 to 11.

FIG. 9 is a view illustrating a configuration of the earset 10F and a configuration of the external device 30 according to still another embodiment.

Referring to FIG. 9, the earset 10F includes the first earphone 110 and the main body 100. The first earphone 110 includes the first speaker 111 and the first microphone 112. The main body 100 includes the button unit 130, a controller 150F, and the communicator 160.

Since the first speaker 111, the first microphone 112, the button unit 130, and the communicator 160 illustrated in FIG. 9 are similar or identical to the first speaker 111, the first microphone 112, the button unit 130, and the communicator 160 described with reference to FIGS. 2 to 6, overlapping descriptions will be omitted, and differences from those in FIGS. 2 to 6 will be mainly described.

The controller 150F of the earset 10F illustrated in FIG. 9 only includes the filter 154, the AD converter 157, and the voice coder 158. When the controller 150F of the earset 10F is configured as illustrated in FIG. 9, the controller 150F may process voice input into the first microphone 112 and transmit a voice signal obtained as a result of the processing to the external device 30. That is, the filter 154 of the controller 150F filters the first voice signal output from the first microphone 112 to remove an acoustic echo and noise therefrom. Also, the AD converter 157 of the controller 150F converts the filtered first voice signal from an analog signal to a digital signal. In addition, the voice coder 158 of the controller 150F codes the first voice signal converted to a digital signal.

Meanwhile, the first earphone 110 in the earset 10F illustrated in FIG. 9 may be substituted with the first earphone 110 illustrated in FIG. 3 or the first earphone 110 and the second earphone 120 illustrated in FIGS. 4 to 6.

Referring to FIG. 9, the external device 30 may include an input unit 320, a display unit 330, a controller 350, and a communicator 360.

The input unit 320 is a part configured to receive a command from a user and may include an inputting means such as a touch pad, a key pad, a button, a switch, a jog wheel, or a combination thereof. The touch pad may form a touch screen by being stacked on a display (not illustrated) of the display unit 330 that will be described below.

The display unit 330 is a part configured to display a result of processing a command and may be realized using a flat panel display or a flexible display. The display unit 330 may be separately realized from the input unit 320 in a hardware form or may be integrally realized with the input unit 320, like a touch screen.

The communicator 360 transmits and receives a signal and/or data to and from the communicator 160 of the earset 10F through the wired and wireless network 20. For example, the communicator 360 may receive the first voice signal transmitted from the earset 10F.

The controller 350 may determine whether the voice correction function is activated and control each of the elements of the external device 30 according to a determination result. Specifically, when the voice correction function is activated, the controller 350 corrects the first voice signal using a reference voice signal. When the voice correction function is deactivated, the controller 350 processes the first voice signal and transmits the processed first voice signal to the external device 30′ of the called party performing a call with the user.

FIG. 10 is a view illustrating a configuration of a controller 350A of the external device 30 according to an embodiment. FIG. 11 is a view illustrating a configuration of a controller 350B of the external device 30 according to another embodiment.

First, referring to FIG. 10, the controller 350A according to an embodiment may include a voice decoder 358, an AD converter 357, a filter 354, and a corrector 353.

The voice decoder 358 decodes the first voice signal received from the earset 10F. The decoded first voice signal is provided to the AD converter 357.

The AD converter 357 converts the decoded first voice signal to a digital signal. The first voice signal converted to a digital signal is provided to the filter 354.

The filter 354 filters the first voice signal converted into the digital signal to remove noise therefrom. The first voice signal from which noise has been removed is provided to the corrector 353.

The corrector 353 corrects the first voice signal using a reference voice signal. For example, the corrector 353 corrects a frequency band of the first voice signal using a frequency band of the reference voice signal, with reference to a correction value. Here, the correction value may be acquired in advance. For example, a correction value acquired in advance by a manufacturer of the earset 10F may be distributed to the external device 30 through the wired and wireless network 20 and stored in the corrector 353.

Next, referring to FIG. 11, the controller 350B according to another embodiment may include the voice decoder 358, the AD converter 357, a gain controller 356, an equalizer 355, the filter 354, and the corrector 353.

The gain controller 356 applies a gain to the first voice signal output by the AD converter 357 to automatically adjust size of the first voice signal. In this way, the first voice signal having a predetermined size may be transmitted to the external device 30′ of the called party.

The equalizer 355 adjusts overall frequency characteristic of the first voice signal output from the gain controller 356. The first voice signal whose frequency characteristic is adjusted is provided to the filter 354.

Various embodiments related to a configuration of the controller 150 of the earset 10 and various embodiments related to a configuration of the controller 350 of the external device 30 have been described above with reference to FIGS. 2 to 11.

According to an embodiment, at least one of the elements included in the controller 150 of the earset 10 and at least one of the elements included in the controller 350 of the external device 30 may be realized in a hardware form. For example, at least one element included in the controller 150 of the earset 10 may be realized in the form of a circuit inside the earset 10, or at least one element included in the controller 350 of the external device 30 may be realized in the form of a circuit inside the external device 30.

According to another embodiment, at least one of the elements included in the controller 150 of the earset 10 and at least one of the elements included in the controller 350 of the external device 30 may be realized in a software form, e.g., a firmware, a voice correction program, or a voice correction application. In this case, the firmware, the voice correction program, or the voice correction application may be provided from a manufacturer of the earset 10 or may be provided from another external device (not illustrated) through the wired and wireless network 20. The firmware, the voice correction program, or the voice correction application may be executed by the earset 10, the external device 30, or the server 40.

According to yet another embodiment, order of arrangement of the elements of the controllers 150 and 350 may be changed. Also, one or more of the elements of the controllers 150 and 350 may be omitted. For example, the controllers 150 and 350 may only include the correctors 153 and 353, only include the filters 154 and 354, only include the equalizers 155 and 355, only include the gain controllers 156 and 356, or include combinations thereof.

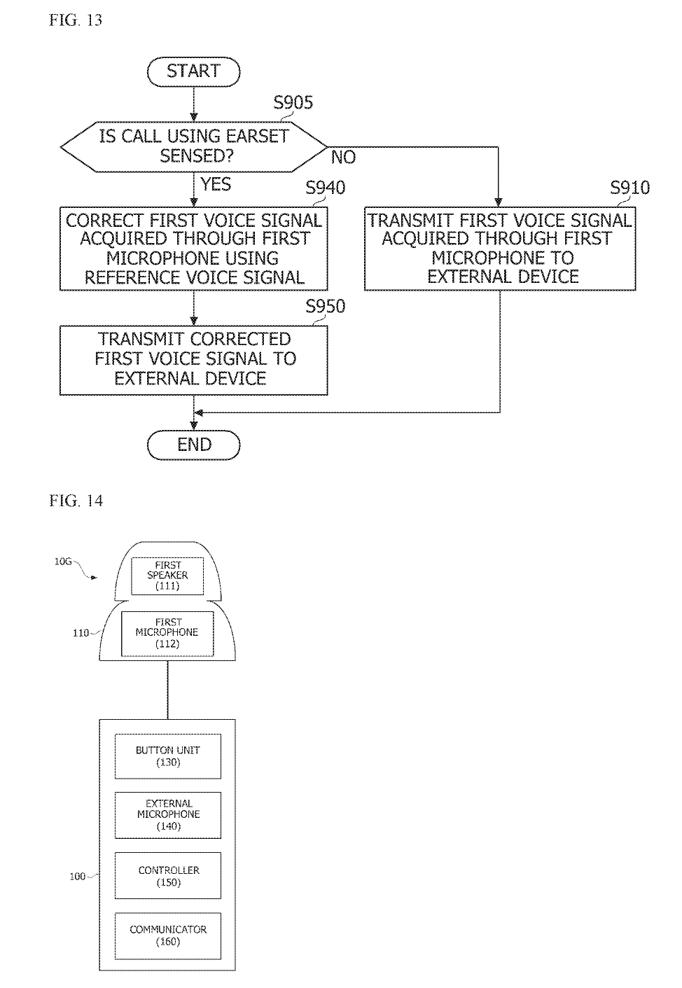

FIG. 12 is a flowchart of a method of controlling the earsets 10A, 10B, 10C, 10D, and 10E described with reference to FIGS. 2 to 8 according to an embodiment. Also, FIG. 13 is a flowchart of a method of controlling the earsets 10A, 10B, 10C, 10D, and 10E described with reference to FIGS. 2 to 8 according to another embodiment.

Prior to making descriptions with reference to FIGS. 12 and 13, it is assumed that the earsets 10A, 10B, 10C, 10D, and 10E are worn in a user's ear. Also, it is assumed that the external voice signal is a reference voice signal.

First, referring to FIG. 12, whether the voice correction function is activated is determined (S900). Whether the voice correction function is determined may be determined based on a manipulation state of the voice correction execution button provided in the button unit 130 of the earsets 10A, 10B, 10C, 10D, and 10E or a presence of a control signal received from the external device 30.

When it is determined that the voice correction function is not activated as a result of Step S900 (NO to S900), the first voice signal acquired through the first microphone 112 is transmitted to the external device 30 (S910). Here, the external device may refer to the external device 30 of the user or the external device 30′ of the called party.

Step S910 may include filtering the first voice signal output from the first microphone 112, converting the filtered first voice signal into a digital signal, coding the converted first voice signal, and transmitting the coded first voice signal to the external device 30. Here, the external device 30 may refer to the external device 30 of the user or the external device 30′ of the called party.

When it is determined that the voice correction function is activated as a result of Step S900 (YES to S900), the first voice signal acquired through the first microphone 112 is corrected using a reference voice signal (S940). According to an embodiment, Step S940 includes correcting a frequency band of the first voice signal acquired through the first microphone 112 using a frequency band of the reference voice signal. Here, the frequency band of the reference voice signal may be stored after being acquired in advance or may be acquired in real time.

The corrected first voice signal is transmitted to the external device 30 through the communicator 160 (S950). Here, the external device 30 may refer to the external device 30 of the user or the external device 30′ of the called party. Call quality may be improved when a voice coming out at a user's ear is corrected using voice coming out of a user's mouth as above.

Meanwhile, a case has been described with reference to FIG. 12, in which whether the voice correction function is activated is determined (S900) and the first voice signal is corrected in the earsets 10A, 10B, 10C, 10D, and 10E and the corrected first voice signal is transmitted to the external device 30 (S940 and S950) or the first voice signal is transmitted to the external device 30 without being corrected (S910) according to a determination result. However, determining whether the voice correction function is activated (S900) does not have to be necessarily performed.

For example, when the button unit 130 is not disposed in the earsets 10A, 10B, 10C, 10D, and 10E or the voice correction execution button is not disposed in the button unit 130, the earsets 10A, 10B, 10C, 10D, and 10E may be controlled by the method illustrated in FIG. 13.

Referring to FIG. 13, whether performing a call using the earsets 10A, 10B, 10C, 10D, and 10E is detected is determined (S905).

When performing a call using the earsets 10A, 10B, 10C, 10D, and 10E is not detected as a result of Step S905, the first voice signal acquired through the first microphone 112 is transmitted to the external device 30 (S910).

When performing a call using the earsets 10A, 10B, 10C, 10D, and 10E is detected as a result of Step S905, the first voice signal acquired through the first microphone is corrected using a reference voice signal (S940). The corrected first voice signal is transmitted to the external device 30 through the communicator 160 (S950).

Meanwhile, all of the steps illustrated in FIG. 12 or FIG. 13 may be performed at the earset 10. Here, some of the steps illustrated in FIG. 12 or FIG. 13 may be substituted with other steps. For example, when the earset 10 includes the controller 150A illustrated in FIG. 7, Step S950 may be substituted with filtering the corrected first voice signal, converting the filtered first voice signal into a digital signal, coding the first voice signal converted into the digital signal, and transmitting the coded first voice signal to the external device 30.

In another example, when the earset 10 includes the controller 150B illustrated in FIG. 8, Step S950 may be substituted with filtering the corrected first voice signal, adjusting overall frequency characteristic of the filtered first voice signal, applying a gain to the first voice signal whose frequency characteristic is adjusted to adjust the size of the first voice signal, converting the first voice signal whose gain is controlled into a digital signal, coding the first voice signal converted into the digital signal, and transmitting the coded first voice signal to the external device 30.

Also, all of the steps illustrated in FIG. 12 may be performed by the external device 30. Here, the method may further include steps other than those illustrated in FIG. 12. For example, when the external device 30 includes the controller 350A illustrated in FIG. 10, decoding the first voice signal output from the first microphone 112, converting the decoded first voice signal into a digital signal, filtering the first voice signal converted into the digital signal, etc. may be further included between Step S900 and Step S940. In this case, the external device in Step S950 may refer to the external device 30′ of the called party.

In another example, when the external device 30 includes the controller 350B illustrated in FIG. 11, decoding the first voice signal output from the first microphone 112, converting the decoded first voice signal into a digital signal, automatically controlling a gain of the first voice signal converted into the digital signal, adjusting overall frequency characteristic of the first voice signal whose gain is controlled, filtering the first voice signal whose frequency characteristic is adjusted, etc. may be further included between Step S900 and Step S940. In this case, the external device in Step S950 may refer to the external device 30′ of the called party.

The earsets 10A, 10B, 10C, 10D, 10E, and 10F including the first microphone 112 and/or the second microphone 122 and methods of controlling the same have been described above with reference to FIGS. 2 to 13. Hereinafter, an earset 10G including the first microphone 112 and the external microphone 140 and a method of controlling the same will be described with reference to FIGS. 14 to 16.

FIG. 14 is a view illustrating a configuration of the earset 10G according to still another embodiment.

Referring to FIG. 14, the earset 10G may include the first earphone 110 and the main body 100.

The first earphone 110 is a part inserted into the first external auditory meatus (an external auditory meatus of the left ear) of or the second external auditory meatus of the user and includes the first speaker 111 and the first microphone 112. The first microphone 112 receives voice coming out at the ear.

Meanwhile, the first earphone 110 of the earset 10G illustrated in FIG. 14 may be substituted with the first earphone 110 illustrated in FIG. 3 or the first earphone 110 and the second earphone 120 illustrated in FIGS. 4 to 6.

Referring again to FIG. 14, the main body 100 is electrically connected to the first earphone 110. The main body 100 includes the button unit 130, the external microphone 140, a controller 150G, and the communicator 160.

Because the button unit 130 and the communicator 160 in FIG. 14 are similar or identical to the button unit 130 and the communicator 160 in FIG. 2, overlapping descriptions will be omitted, and the external microphone 140 and the controller 150G will be mainly described.

The external microphone 140 receives voice coming out of a user's mouth. For example, the external microphone 140 may always remain activated. In another example, the external microphone 140 may be activated or deactivated according to a manipulation state of a button disposed in the button unit 130 or a control signal received from the external device 30. In yet another example, the external microphone 140 may be activated when a user's voice is detected and deactivated when a user's voice is not detected.

Because the main body 100 is exposed outside the user's ear, the external microphone 140 is also exposed outside the user's ear. Consequently, voice coming out of the user's mouth is input into the external microphone 140. When voice is input into the external microphone 140, the external microphone 140 outputs an external voice signal which is a voice signal related to the input voice. Then, the external voice signal output from the external microphone 140 is analyzed, and information on the external voice signal is detected. For example, the information on the external voice signal may include information on a frequency band thereof. However, the information on the external voice signal is not necessarily limited thereto.

The external microphone 140 may remain activated or may be changed into a deactivated state while a call is being made. According to an embodiment, state of the external microphone 140 may be changed manually. For example, when the user manipulates the button unit 130 or the external device 30, the external microphone 140 may be switched from an activated state to a deactivated state. In another example, the external microphone 140 may be activated and then automatically be deactivated after a predetermined amount of time.

Although a case in which a single external microphone 140 is disposed is illustrated in FIG. 14, one or more external microphones 140 may be disposed. A plurality of external microphones 140 may be disposed at different positions.

When the voice correction function is activated, the controller 150G confirms the type of the reference voice signal and corrects a voice signal according to the confirmation result.

For example, when the external voice signal is a reference voice signal, the controller 150G corrects voice coming out at the user's ear using a reference voice, i.e., voice coming out of the user's mouth. Specifically, the controller 150G corrects a frequency band of a voice input into the first microphone 112 using a frequency band of voice coming out of the user's mouth and transmits the voice signal whose frequency band is corrected to the external device 30.

In another example, when the first voice signal is a reference voice signal, the controller 150G corrects voice coming out of the user's mouth using a reference voice, i.e., voice coming out at the user's ear. Specifically, the controller 150G corrects a frequency band of voice input into the external microphone 140 using a frequency band of voice input into the first microphone 112 and transmits the voice signal whose frequency band is corrected to the external device 30.

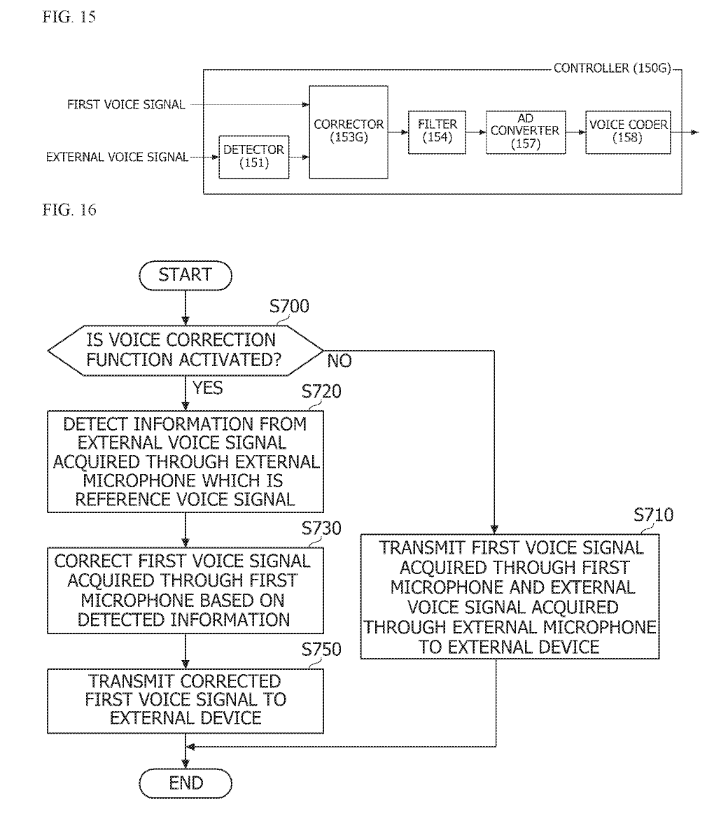

When the voice correction function is deactivated, the controller 150G processes voice input into the first microphone 112 and transmits the processed voice signal to the external device 30. For this, the controller 150G may include a detector 151, a corrector 153G, the filter 154, the AD converter 157, and the voice coder 158 as illustrated in FIG. 15.

Referring to FIG. 15, the detector 151 may detect information on a reference voice signal. Here, the reference voice signal may refer to the first voice signal acquired through the first microphone 112 or may refer to the external voice signal acquired through the external microphone 140.

Also, the information on a reference voice signal may include information on a reference frequency band but is not necessarily limited thereto. The information on a reference frequency band detected by the detector 151 may be used as a reference value for correcting a voice signal. For example, when the external voice signal is a reference voice signal, the information on a reference frequency band detected by the detector 151 may be used as a reference value for correcting the first voice signal acquired through the first microphone 112. In another example, when the first voice signal is a reference voice signal, the information on a reference frequency band detected by the detector 151 may be used as a reference value for correcting the external voice signal acquired through the external microphone 140.

The corrector 153G corrects the first voice signal output from the first microphone 112 or the external voice signal output from the external microphone 140 using a reference voice signal. For example, the corrector 153G corrects a frequency band of the first voice signal using a frequency band of the external voice signal which is a reference voice signal. In another example, the corrector 153G corrects a frequency band of the external voice signal using a frequency band of the first voice signal which is a reference voice signal.

With reference to information on a reference voice signal detected by the detector 151, according to an embodiment, the corrector 153G corrects a frequency band of the first voice signal output from the first microphone 112 using a reference frequency band of a reference voice signal or corrects a frequency band of the external voice signal output from the external microphone 140 using a frequency band of a reference voice signal.

According to another embodiment, the corrector 153G may determine the type of voice signal output from the first microphone 112, e.g., gender of the voice, based on the information on a reference voice signal detected by the detector 151. When the first voice signal output from the first microphone 112 corresponds to a female voice signal as a result of the determination, the corrector 153G corrects the frequency band of the first voice signal using a first reference frequency band. When a first voice signal output from the first microphone 112 corresponds to a male voice signal, the corrector 153G corrects the frequency band of the first voice signal using a second reference frequency band.

Here, information on the first reference frequency band refers to information on a female voice. The information on the first reference frequency band may be obtained by, for example, collecting and analyzing voices of hundred women. In contrast, the information on the second reference frequency band refers to information on a male voice. The information on the second reference frequency band may be obtained by, for example, collecting and analyzing voices of hundred men. The information on the first reference frequency band and the information on the second reference frequency band experimentally acquired in advance as above may be stored in the corrector 153G.

The filter 154 filters a voice signal whose frequency band is corrected to remove an acoustic echo and noise therefrom, the AD converter 157 converts the voice signal, from which acoustic echo and noise have been removed, from an analog signal to a digital signal, and the voice coder 158 codes the voice signal converted into the digital signal.

FIG. 16 is a flowchart illustrating a method of controlling the earset 10G described with reference to FIGS. 14 and 15 according to an embodiment.

Prior to making description with reference to FIG. 16, it is assumed that the earset 10G and the external device 30 communicate with each other according to a wireless communication means and that a pairing process has been completed between the earset 10G and the external device 30. Also, it is assumed that the earset 10G is worn in a user's ear. In addition, it is assumed that the external voice signal acquired through the external microphone 140 is a reference voice signal.

First, whether the voice correction function is activated is determined (S700). Whether the voice correction function is activated may be determined based on a manipulation state of the voice correction execution button provide in the button unit 130 or the presence of a control signal received from the external device 30.

When it is determined that the voice correction function is not activated as a result of Step S700 (NO to S700), each of the first voice signal acquired through the first microphone 112 and the external voice signal acquired through the external microphone 140 is transmitted to the external device 30 (S710). Here, the external device may refer to the external device 30 of the user or the external device 30′ of the called party.

When it is determined that the voice correction function is activated as a result of Step S700 (YES to S700), information on the external voice signal acquired through the external microphone 140 which is a reference voice signal is detected (S720).

According to an embodiment, after the information on the reference voice signal is detected, the first voice signal acquired through the first microphone 112 is corrected based on the detected information (S730).

According to another embodiment, after the information on the reference voice signal is detected, determining the type of the first voice signal acquired through the first microphone 112, e.g., gender of the voice, is performed based on the detected information. When the first voice signal acquired through the first microphone 112 is a female voice signal as a result of the determination, correcting of the frequency band of the first voice signal is performed, using the first reference frequency band. When the first voice signal acquired through the first microphone 112 is a male voice signal as a result of the determination, correcting the frequency band of the first voice signal is performed, using the second reference frequency band.

The corrected first voice signal is transmitted to the external device 30 through the communicator 160 (S750). Step S750 may include filtering the corrected first voice signal by the filter 154 to remove an acoustic echo and noise therefrom, converting the filtered first voice signal from an analog signal to a digital signal by the AD converter 157, and coding the first voice signal converted into the digital signal by the voice coder 158.

When a frequency band of a voice coming out at a user's ear is corrected using a reference frequency band as described above, call quality may be improved because an effect similar to that of correcting a frequency band of a voice coming out at the user's ear using a frequency band of a voice coming out of the user's mouth may be obtained.

Meanwhile, a case in which whether the voice correction function is activated is determined (S700) and a voice signal is corrected in the earset 10G (S720 to S750) or a voice signal is transmitted to the external device 30 without being corrected (S710) according to a determination result has been described with reference to FIG. 16. However, determining whether the voice correction function is activated (S700) does not have to be necessarily performed. For example, when the button unit 130 is not disposed or the voice correction execution button is not disposed in the button unit 130, Steps S700 and S710 may be omitted in FIG. 16.

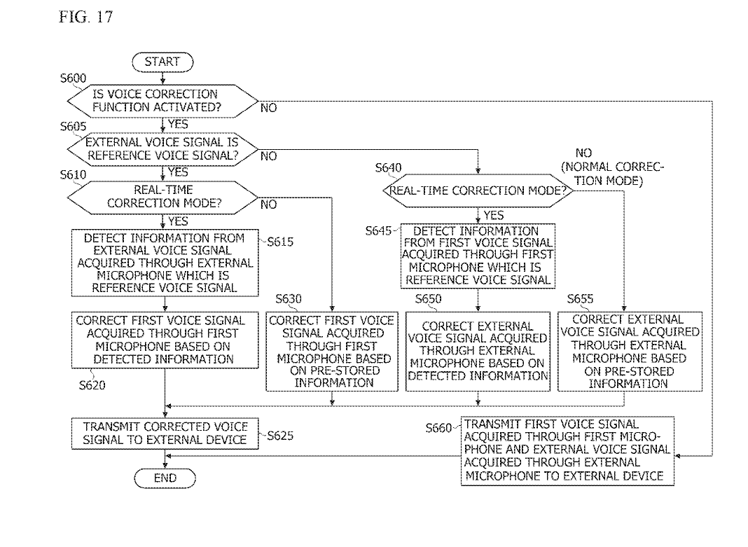

FIG. 17 is a flowchart of a method of controlling the earset 10G according to another embodiment and is a more detailed version of the flowchart illustrated in FIG. 16.

Referring to FIG. 17, whether the voice correction function is activated is determined (S600).

When it is determined that the voice correction function is not activated as a result of Step S600, each of the first voice signal acquired through the first microphone 112 and the external voice signal acquired through the external microphone 140 is transmitted to the external device 30 (S660).

When it is determined that the voice correction function is activated as a result of Step S600, whether the external voice signal is a reference voice signal is determined (S605).

When it is determined that the external voice signal is set as a reference voice signal as a result of Step S605, it is determined that a voice signal coming out at a user's ear is set to be corrected using a voice signal coming out of the user's mouth.

Then, whether a set voice correction mode is a real-time correction mode is determined (S610).

When it is determined that the voice correction mode is not the real-time correction mode, i.e., is a normal correction mode, as a result of Step S610, the first voice signal acquired through the first microphone 112 is corrected based on pre-stored information (S630).

When it is determined that the voice correction mode is the real-time correction mode as a result of Step S610, information is detected from the external voice signal acquired through the external microphone 140 which is a reference voice signal (S615).

Then, the first voice signal acquired through the first microphone 112 is corrected based on the detected information (S620).

The corrected voice signal is transmitted to the external device 30 through the communicator 160 (S625). Step S625 may include filtering the corrected voice signal by the filter 154 to remove an acoustic echo and noise therefrom, converting the filtered voice signal from an analog signal to a digital signal by the AD converter 157, and coding the voice signal converted into the digital signal by the voice coder 158.

Meanwhile, when it is determined that the external voice signal is not a reference voice signal as a result of Step S605, i.e., the first voice signal is set as a reference voice signal, it is determined that a voice signal coming out of a user's mouth is set to be corrected using a voice signal coming out at the user's ear.

Then, whether the set voice correction mode is a real-time correction mode is determined (S640).

When it is determined that the voice correction mode is not the real-time correction mode, i.e., is a normal correction mode, as a result of Step S640, the external voice signal acquired through the external microphone 140 is corrected based on pre-stored information (S655).

When it is determined that the voice correction mode is the real-time correction mode as a result of Step S640, information is detected from the first voice signal acquired through the first microphone 112 which is a reference voice signal (S645).

Then, the external voice signal acquired through the external microphone 140 is corrected based on the detected information (S650).

A case in which the corrector 150G of the earset 10G corrects the first voice signal or the external voice signal using a reference voice signal based on reference frequency band information acquired in real time or reference frequency band information acquired in advance has been described as an example with reference to FIGS. 14 to 17.

According to another embodiment, the corrector 150G of the earset 10G may also correct the first voice signal or the external voice signal based on reference frequency band information acquired in real time by the controller 350 of the external device 30. In this case, the controller 350 of the external device 30 may further include a detector 351 disposed behind the filter 354, and the corrector 353 may be omitted (refer to FIGS. 10 and 11). Here, when voice coming out of a user's mouth is input into a microphone (not illustrated) disposed in the external device 30, the detector 351 may also analyze a voice signal output from the microphone in the external device 30 to detect reference frequency band information.

In addition to the detector 351, the controller 350 of the external device 30 may further include at least one of the voice decoder 358, the AD converter 357, the gain controller 356, the equalizer 355, and the filter 354.

According to yet another embodiment, the corrector 153G of the earset 10G may also analyze the first voice signal output from the first microphone 112 to estimate reference frequency band information and correct the first voice signal based on the estimated reference frequency band information. Alternatively, the corrector 153G of the earset 10G may also analyze the external voice signal output from the external microphone 140 to estimate reference frequency band information and correct the external voice signal based on the estimated reference frequency band information. For this, the corrector 153G may refer to an estimation algorithm. According to an embodiment, the estimation algorithm may include a frequency correction algorithm, a gain correction algorithm, an equalizer correction algorithm, or a combination thereof. The estimation algorithm may be stored in the corrector 153G when the earset 10G is manufactured. Also, the estimation algorithm stored in the corrector 153G may also be updated by communicating with the external device 30.

According to still another embodiment, instead of determining whether the voice correction function is activated, voice signal correction may be performed based on a result of comparison between the first voice signal acquired through the first microphone 112 and the external voice signal acquired through the external microphone 140. Specifically, when quality of the first voice signal acquired through the first microphone 112 is better than that of the external voice signal acquired through the external microphone 140, the external voice signal may be corrected based on the first voice signal. When quality of the external voice signal acquired through the external microphone 140 is better than that of the first voice signal acquired through the first microphone 112, the first voice signal may be corrected based on the external voice signal.

Call quality can be improved because voice coming out at a user's ear is corrected using a voice coming out of the user's mouth.

Embodiments of the present disclosure have been described above with reference to the accompanying drawings. In the embodiments described above, a case in which the controller 150 of the earset 10 or the controller 350 of the external device 30 converts a frequency of the first voice signal and/or the external voice signal, removes an acoustic echo and noise, or adjusts a frequency characteristic (i.e., adjusts a characteristic of an equalizer) to correct voice coming out at a user's ear using a voice coming out of the user's mouth or correct voice coming out of a user's mouth using voice coming out at the user's ear has been described as an example. Moreover, voice signal processing including frequency extension, noise suppression, noise cancellation, Z-transformation, S-transformation, FFT or a combination thereof may be further performed. Also, a case in which the earset 10 includes the main body 100 has been described above as an example. Although not illustrated in the drawings, the main boy 100 may also be omitted in the earset 10 according to another embodiment. In this case, elements of the main body 100 of the earset 10 may be disposed in the external device 30.

In addition to the embodiments described above, embodiments of the present disclosure may also be realized using a medium including a computer readable code or an instruction for controlling at least one processing element of the embodiments described above, e.g., a computer readable medium. The medium may correspond to a medium or media that enables the computer readable code to be stored and/or transmitted.

The computer readable code may be recorded in a medium as well as transmitted through the Internet. The medium may include, for example, a recording medium such as a magnetic storage medium (e.g., a read-only memory (ROM), a floppy disk, a hard disk, etc.) and an optical recording medium (e.g., a compact disk (CD)-ROM, Blu-Ray, a digital versatile disk (DVD)) and a transmission medium such as a carrier wave. Because the media may be distributed networks, a computer readable code may be executed after being stored or transmitted in a distributed manner. Also, moreover, a processing element may include a processor or a computer processor merely as an example, and the processing element may be distributed and/or included in a single device.

Although embodiments of the present disclosure have been described above with reference to the accompanying drawings, one of ordinary skill in the art to which the present disclosure pertains should understand that the present disclosure may be performed in other specific forms without changing the technical spirit or essential features of the present disclosure. Thus, embodiments described above are illustrative in all aspects and should not be understood as limiting.

### DESCRIPTION OF REFERENCE NUMERALS

1: Earset system
10: Earset
30: External device
100: Main body
110: First earphone
120: Second earphone

What is claimed is:

1. An earset system comprising:
an earset having a first earphone inserted into a user's ear and having a first microphone configured to receive voice coming out at the user's ear; and
a controller configured to correct, based on a correction value, a first voice signal acquired through the first microphone or a voice signal coming out of the user's mouth using a reference voice signal.

2. The earset system of claim 1, wherein, based on the correction value, the controller includes a corrector configured to correct the first voice signal using a voice signal coming out of the user's mouth which is the reference voice signal or correct a voice signal coming out of the user's mouth using the first voice signal which is the reference voice signal.

3. The earset system of claim 2, wherein the correction value is acquired by analyzing the reference voice signal in advance.

4. The earset system of claim 3, wherein the correction value is stored in at least one of the earset and an external device of the user linked to the earset.

5. The earset system of claim 4, wherein the correction value stored in the earset is transmitted to the external device according to wired and wireless communication means, or the correction value stored in the external device is transmitted to the earset according to wired and wireless communication means.

6. The earset system of claim 2, wherein the correction value is acquired or estimated in real time from the first voice signal.

7. The earset system of claim 2, wherein the correction value is acquired or estimated in real time from an external voice signal acquired through one or more external microphones.

8. The earset system of claim 7, wherein the one or more external microphones are disposed in at least one of a main body connected to the first earphone and an external device linked to the earset.

9. The earset system of claim 7, wherein the one or more external microphones are automatically activated when voice coming out of the user's mouth is sensed.

10. The earset system of claim 9, wherein the one or more external microphones are automatically deactivated after voice coming out of the user's mouth is input.

11. The earset system of claim 7, wherein the one or more external microphones are automatically deactivated when a voice coming out of the user's mouth is not sensed.

12. The earset system of claim 2, wherein the corrector:
distinguishes the type of the reference voice signal based on information detected from the reference voice signal;
corrects a frequency band of the first voice signal using a first reference frequency band acquired by analyzing a female voice when the type of the reference voice signal corresponds to a female voice signal; and
corrects the frequency band of the first voice signal using a second reference frequency band acquired by analyzing a male voice when the type of the reference voice signal corresponds to a male voice signal.

13. The earset system of claim 12, wherein the controller includes a detector configured to detect information from the reference voice signal.

14. The earset system of claim 13, wherein at least one of the detector and the corrector is installed as a circuit or stored in a software form in at least one of the earset and an external device of the user linked to the earset.

15. The earset system of claim 2, wherein the corrector includes at least one of a filter, an equalizer, and a gain controller.

16. The earset system of claim 2, wherein the controller further includes at least one of a filter, an equalizer, and a gain controller.

17. The earset system of claim 1, wherein the controller performs voice signal processing of at least one of the first voice signal and the voice signal coming out of the user's mouth.

18. The earset system of claim 17, wherein the voice signal processing includes transforming a frequency of a voice signal, extending the frequency of the voice signal, controlling gain of the voice signal, adjusting a frequency characteristic of the voice signal, removing an acoustic echo from the voice signal, removing noise from the voice signal, suppressing noise from the voice signal, cancelling noise from the voice signal, Z-transformation, S-transformation, Fast Fourier Transform (FFT), or a combination thereof.

19. The earset system of claim 1, wherein the first earphone includes a first speaker configured to output an acoustic signal or a voice signal received from an external device.

20. The earset system of claim 1, wherein the earset further includes a second earphone inserted into the user's ear, and the second earphone includes at least one of a second microphone and a second speaker.
